(19) United States
(12) Patent Application Publication
(10) Pub. No.: US 2004/0101112 A1
(43) Pub. Date: May 27, 2004

(54) Voice identification method for cellular phone and cellular phone with voiceprint password

(75) Inventor: Horngyuh Kuo, Hsinchu (TW)

Correspondence Address: BACON & THOMAS, PLLC, 625 SLATERS LANE, FOURTH FLOOR, ALEXANDRIA, VA, 22314

(73) Assignee: LITE-ON TECHNOLOGY CORPORATION, Taipei (TW)

(21) Appl. No.: 10/396,472

(22) Filed: Mar. 26, 2003

(30) Foreign Application Priority Data
Nov. 26, 2002 (TW) 91134293

(51) Int. Cl. H04M 1/64

(52) U.S. Cl. 379/88.01; 455/563

(57) ABSTRACT

The present invention discloses a voice identification method for cellular phone, which comprises the following steps: asking a user to input his voice through a microphone in a cellular phone when the cellular phone is used first time; analyzing and drawing out the voiceprint characteristics of the voice and then storing it in a memory as a voiceprint password; asking the user to input his voice when the cellular phone is turned on every time afterwards; comparing the input voice with the voiceprint password stored in the cellular phone; then the cellular phone is ready to function if the input voice conforms to the voiceprint password. Thereby, burglarproof effect and data security can be achieved.

### FIELD OF THE INVENTION

The present invention relates to a voice identification method for cellular phone and a cellular phone with voiceprint password. In particularly, the present invention relates to a method for activating a cellular phone by using a voiceprint password stored in the cellular phone.

### BACKGROUND OF THE INVENTION

How to identify a user is a key to settle the exited issues regarding data security and loss of a cellular phone. In current cellular phone application, a password should be input into a cellular phone by pressing a keyboard on the cellular phone. Also, a user always locks the cellular phone by pressing the keyboard when the cellular phone is idle. In practice, such a pressing manner is inconvenient and the password is easily decrypted.

Further, voice identification is mature now from the point view of technical level. And, the components required by performing the voice identification are few. The voice identification is only used to identify the voice of the owner of the cellular phone and is different from the sound dialing method developed few years ago.

Therefore, applying the voice identification technique on a cellular phone is practicable.

### SUMMARY OF THE INVENTION

To allow a cellular phone to identify a user, the present inventor develops an identification system combining with a voiceprint identification mechanism in a Man-Machine Interface (MMI) environment. Therefore, the present invention provides a method for unlocking a cellular phone by inputting voice and a cellular phone having a voiceprint identification lock. The method for unlocking a cellular phone by inputting voice according to the present invention comprises the steps of first storing a user's voiceprint data in the cellular phone, asking the user to input his voice before operation, and comparing the input voice with the voiceprint data by the voiceprint identification lock.

Thus, the main object of the present invention is to provide a method for unlocking a cellular phone by inputting voice and a cellular phone having a voiceprint identification lock, thereby burglarproof effect and data security can be achieved through the sound unlocking mechanism.

The other object of the present invention is to provide a method for unlocking a cellular phone by inputting voice and a cellular phone having a voiceprint identification lock, thereby operation on a cellular phone can be more convenient and interesting through the sound unlocking.

The further object of the present invention is to provide a method for unlocking a cellular phone by inputting voice and a cellular phone having a voiceprint identification lock, thereby a security of the cellular phone system can be achieved due to the exclusive voiceprint.

These objects and the other objects, features, and advantages will be apparent to those people skilled in the art from the following detailed description in connection with the drawings.

### BRIEF DESCRIPTION OF THE DRAWINGS

FIG. 1 is a block diagram showing a circuit of a cellular phone having a voiceprint identification lock according to an embodiment of the present invention;

FIG. 2 is a flow chart showing the procedures of a method for unlocking a cellular phone by inputting voice according to an embodiment of the present invention; and

FIG. 3 is a flow chart showing operation procedures of a method for unlocking a cellular phone by inputting voice according to an embodiment of the present invention.

### DETAILED DESCRIPTION OF THE INVENTION

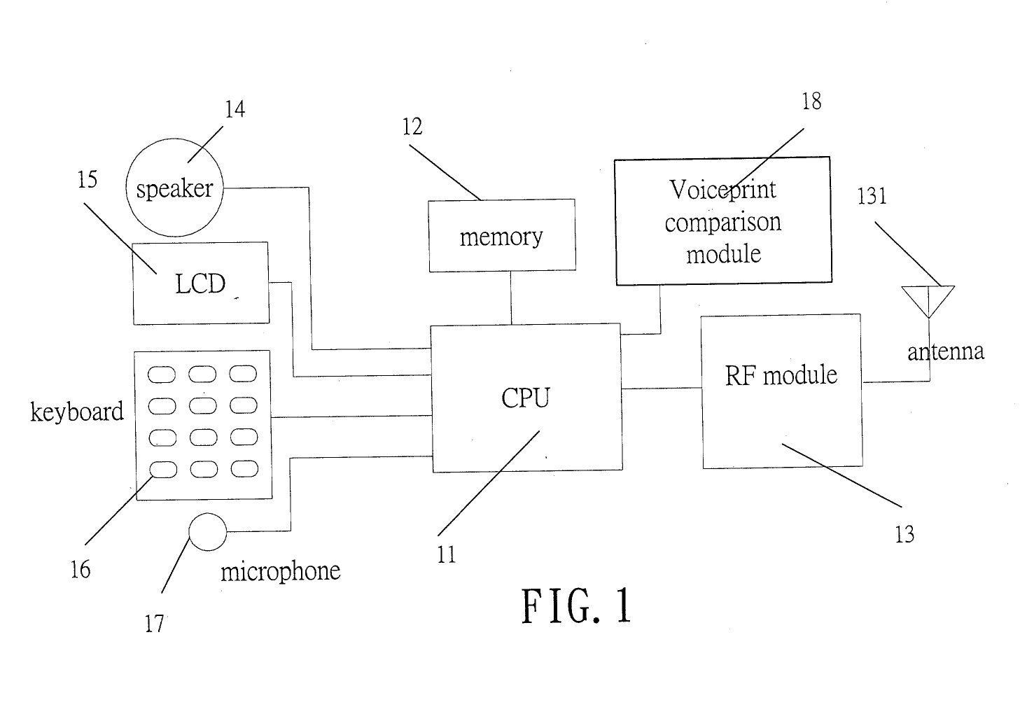

First of all, please refer to FIG. 1. FIG. 1 shows the structure of the cellular phone according to the present invention. From FIG. 1, a cellular phone 1 mainly comprises a central processing unit (CPU) 11, memory 12, radio frequency module 13, speaker 14, liquid crystalline display 15, keyboard 16, and microphone 17. Among others, the radio frequency module 13 connects an antenna 131 for receiving/emitting signal. Comparing with a conventional cellular phone, the cellular phone having a voiceprint identification lock according to the present invention further includes a voiceprint comparison module 18. In the structure of the cellular phone according to the present invention, the microphone 17 is used for inputting voice. The first step for identifying a voiceprint is to record the user's voice. To perform the recording function on the cellular phone, it is possible to write a control element capable of recording sound. The control element capable of recording sound provides an interface for communicating with MMI. The MMI can access the recorded voiceprint through the interface and compare the recorded voiceprint with the voiceprint stored in the memory. If the recorded voiceprint conforms to the voiceprint stored in the memory, the cellular phone is allowed to function. The memory 12 is used for storing the voiceprint data. The voiceprint-comparison module 18 is used for identifying the voiceprint to perform the method for unlocking a cellular phone by inputting voice according to the present invention.

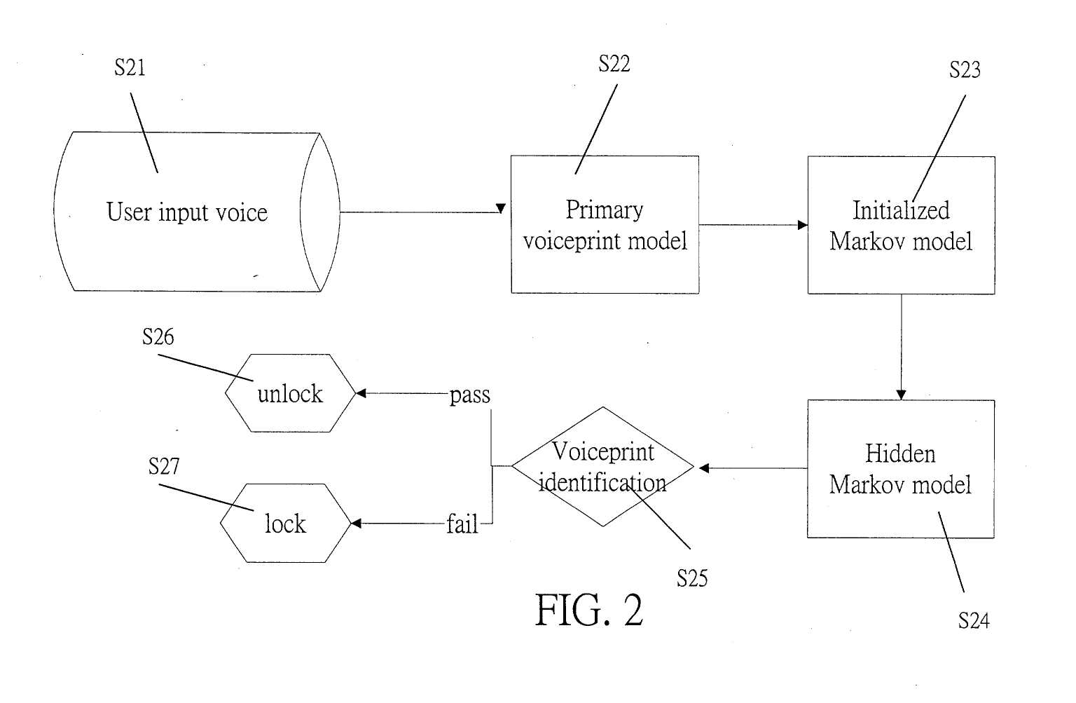

The steps of the method for unlocking a cellular phone by inputting voice according to the present invention are illustrated in FIG. 2. FIG. 2 is a flow chart for comparing voiceprint by using a hidden Markov Model. First, a user input voice (step S21), the central processing unit 11 transforms the input voice into an initially voiceprint model (step S22) through the voiceprint comparison module 18. Then, the initially voiceprint model is transformed into an initialized hidden Markov Model (step S23) then further transformed into a hidden Markov Model (step S24). Subsequently, voiceprint identification (step S25) is performed. If the voiceprint identification is passed, the cellular phone is allowed to function. If the voiceprint identification is failed, the cellular phone is still locked and does not function. Among others, the hidden Markov Language Model is a process for integrating a dynamic dictionary mechanism into the Markov Model, thereby the integrated model possesses both the capability of the Markov Language Model for quickly and progressively processing the syllable and the ability of non-supervision style learning. Upon using the Language Model, it uses nine states to establish a model for each Chinese word, and a silence state is inserted between words. By performing mathematical calculation associated with the hidden Markov Language Model according to this model, an optimal voiceprint characteristic model can be obtained. Such a model will tend to become stability through training and then is used to identify the user.

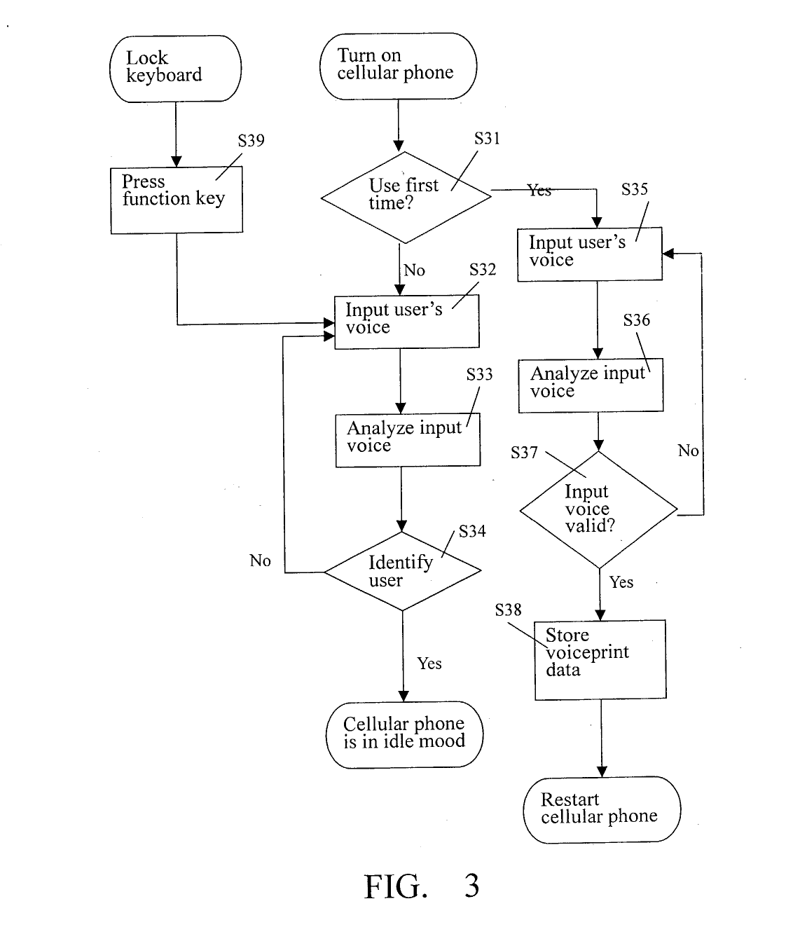

Finally, please refer to FIG. 3. FIG. 3 is a flow chart for showing the steps performing the method for unlocking a cellular phone by inputting voice according to the present invention. When a cellular phone is turned on, it checks whether the phone is first-time used (step S31). If so, the cellular phone asks the user to input his voice (step S35). The voiceprint characteristic of the input voice will be analyzed (step S36). Then, the cellular phone checks whether the input voice is valid (step S37). The flow goes back to step S35 to ask the user to input his voice again if the answer is not. If it is valid, the cellular phone stores the voiceprint data (step S38) and restart. Then back to step S31, if the cellular phone is not first time used, the cellular phone asks the user to input his voice (step S32). The voiceprint characteristic of the input voice is analyzed (step S33) and is compared to the input voiceprint with the stored voiceprint characteristic to identify the user (step S34). If the input voiceprint conforms to the stored voiceprint characteristic, the cellular phone functions. If the input voiceprint does not conform to the stored voiceprint characteristic, it will go back to step S32 to ask the user to input his voice again. Additionally, if the cellular phone is in a keyboard locking state, press a functional key (step S39) then go to step S32. The cellular phone asks the user to input his voice and continue the above-mentioned steps.

Although the present invention has been described by the above embodiment, the present invention is not limited by the embodiment. Person skilled in the art would make various changes or modification without departing from the spirit and the scope of the present invention. The present invention is only limited by the appended claims.

What is claim is:

1. A voice identification method for a cellular phone, which comprises the following steps:
(1) asking a user to input his voice through a microphone in a cellular phone when the cellular is used at the first time; analyzing and drawing out voiceprint characteristics of said voice to store said voiceprint characteristic in a memory as a voiceprint password;
(2) asking said user to input his voice when said cellular phone is turned on every time; comparing said input voice with said voiceprint password stored in said cellular phone; then
(3) determining whether said user is allowed to operate said cellular phone based on a comparing result from step (2).

2. The voice identification method according to claim 1, wherein the step (3) is carried out after said cellular phone is turned on or a keyboard lock is released.

3. The voice identification method according to claim 2, wherein said cellular phone is ready to work if said input voice conforms to the voiceprint password; and said cellular phone is not working if said input voice does not conform to said voiceprint password.

4. The voice identification method according to claim 1, wherein said voice is said user's name.

5. A cellular phone having a voiceprint identification lock, comprising a central processing unit (CPU), speaker, liquid crystalline display, keyboard, microphone, memory, radio frequency module, and antenna; said cellular phone is characterized that cellular phone further comprises a voiceprint-comparison module for comparing voiceprint and said memory can be used for storing voiceprint data.
